(19) United States
(12) Patent Application Publication
(10) Pub. No.: US 2008/0312983 A1
(43) Pub. Date: Dec. 18, 2008

(54) DYNAMIC RISK MANAGEMENT

(75) Inventor: Nagendra CHAKKA, Phoenix, AZ (US)

Correspondence Address: FITZPATRICK CELLA HARPER & SCINTO, 30 ROCKEFELLER PLAZA, NEW YORK, NY, 10112, US

(73) Assignee: American Express Travel Related Services Co., Inc., New York, NY (US)

(21) Appl. No.: 11/763,819

(22) Filed: Jun. 15, 2007

(51) Int. Cl. G06Q 10/00; G06F 17/50

(52) U.S. Cl. 705/7; 705/1

(57) ABSTRACT

Methods and systems of managing project risk in a business environment are provided. In the methods, the presence of mitigation solutions is taken into consideration prior to the occurrence of project-associated risks, thus minimizing negative impact when the risks occur. Project risk levels can be dynamically updated, thus allowing a user to capture and review accurate risk levels for multiple interdependent projects at any point in time.

### BACKGROUND OF THE INVENTION

1. Field of the Invention

The present invention relates generally to risk management, and more specifically to managing project risk in a business environment.

2. Related Art

Business environments often involve managing a large number of projects that each have one or more associated risks, such as lack of funding, lack of hardware, or lack of staffing. The associated risks often need to be considered prior to beginning a successful project and/or while executing the project. Even vigilant project managers sometimes find these issues difficult to track and address in a timely manner, especially when a number of projects must be managed. Moreover, projects are frequently dependent on the progress of other projects; thus, in order to successfully manage the associated risks of one project, the risks of many interdependent projects must also be considered.

Software programs and methods are currently available for helping managers monitor project risks, but such programs and methods do not adequately take mitigation solutions into consideration prior to the occurrence of risk events. Thus, when a risk event occurs, a project is subjected to adverse effects, such as an interruption in workflow that can result in expenditures of overtime and the use of additional, more costly resources that might not otherwise have been required.

Further, current software programs and methods do not adequately update risk levels for projects as those risk levels increase or decrease over time.

The present invention provides for dynamic risk management that solves the above and other problems relating to the management of projects.

### BRIEF DESCRIPTION OF THE INVENTION

The present invention provides a method of managing project risk in a business environment. The method comprises receiving a risk description (e.g., a description identifying the nature of a risk), a first priority (which refers to the importance and/or the urgency attached to a specific risk), a second priority, and a target time (e.g., a set time by which a mitigation plan should be formed for addressing a specific risk). In the method, a priority value of the risk description is set to be equal to the first priority, a current time is compared with the target time, and the presence of a mitigation plan associated with the risk description is determined. The priority value of the risk description is set to be equal to the second priority if no mitigation plan associated with the risk description is present and the current time is after the target time. The method can further comprise prompting for entry of a mitigation plan if no such plan is present.

In another embodiment, the invention provides another method of managing project risk in a business environment. The method involves receiving first risk information comprising information regarding one or more risks associated with a first project, setting a first project risk status based on the first risk information, receiving second risk information comprising information regarding one or more risks associated with a second project, and setting a second project risk status based on the second risk information. The method also involves checking whether the first project depends on the second project, and if so, setting the first project risk status based on the first risk information and the second risk information. This method can further comprise checking whether the second project depends on the first project, and if so, setting the second project risk status based on both the second risk information and the first risk information.

An advantage of the present invention is that mitigation solutions are more likely to be taken into consideration prior to the occurrence of various risk events associated with projects. Thus, should a risk event occur, adverse effects can be minimized or possibly eliminated.

Another advantage of the present invention is that the risk levels associated with multiple projects may be dynamically updated, that is, updated as changes occur in one or more of the risk levels over time. Therefore, at any given point in time, the actual risk levels of various projects can be reviewed.

Further features and advantages of the present invention will become more apparent in view of detailed description of the present invention, taken together with the accompanying drawings, in which the left-most digit of a reference number identifies the drawing in which the reference number first appears.

### BRIEF DESCRIPTION OF THE DRAWING

FIG. 1 shows an exemplary graphic user interface used in a method of managing project risk according to the present invention.

FIG. 2 is a flowchart illustrating steps in a method of managing project risk according to the present invention.

FIG. 3 shows a graphical user interface used to link related projects together in a method of managing risk according to the present invention.

FIG. 4 is a flowchart illustrating risk inheritance of one project from another project in a method of managing risk according to the present invention.

FIG. 5 shows a sample report of the risk status of several projects being managed in a method of managing risk according to the present invention.

FIG. 6 shows a computer system that can be used in methods of managing project risk in a business environment according to the present invention.

### DETAILED DESCRIPTION

### Definitions

As used herein, the term “risk” refers to an uncertain event or condition that, if it occurs, will have a positive or negative effect on a project. A “risk description” identifies the nature of a risk, such as, for example, “running out of funding,” “hardware failure,” or “lack of human resources.”

“Priority” and “priority value” indicate the importance and/or the urgency attached to a specific risk. For example, the risk of hardware failure on a software development project may be assigned a priority of 50, while the risk of running out of funding on the same project may be assigned a priority of 20. In this example, the risk of hardware failure has a higher priority, indicating that it is a greater risk for the project.

While higher numerical value is correlated with higher priority in the above example, other correlation systems may be used. For example, a lower numerical value can be correlated with higher priority, such that a priority of 1 indicates a risk of great importance and a priority of 15 indicates a risk of less comparative importance. Further, priorities can be arranged on an infinite scale (for example, from 1 to infinity) or on a finite scale (for example, from 1 to 30).

“Target time” refers to a set time by which a mitigation plan should be formed (or implemented) for addressing a specific risk. The target time can be the time elapsing after an initial time (for example, seven days after the time that a risk description is identified) or a particular time not necessarily related to an initial time (for example, by 3:00 PM on September 27).

“Mitigation” refers to reducing the probability and/or the consequences of an adverse risk event to an acceptable threshold. Taking early action to reduce the probability that a risk will occur, or to reduce the impact of a risk on a project, can be more effective than trying to address consequences after the risk has already occurred. A “mitigation plan” refers to any planned response to a particular risk.

The “risk status” of a project refers to a resultant level of risk associated with the project based on all of the risks associated with the project.

“Dependency status” refers to whether one project is contingent in one or more ways on another project. For example, a project of developing a software program may be contingent on the project of acquiring a computer for a software engineer to use. Thus, there is a positive dependency status for the software program development project. In this example, the project of acquiring a computer can also have a positive dependency status if it is contingent in some way upon a third project, such as, for instance, hiring an employee who purchases electronics for the business. Furthermore, two projects can depend on each other, making them interdependent.

When a first project depends on a second project, the first project “inherits” the risks of the second project. In the above example, a first project of developing a software program depends on a second project of acquiring a computer. If the second project is at risk of insufficient funds, then the first project is subject to the same risk, since the first project inherits the risk of the project on which it depends. Thus, in this instance, if the second project runs out of money to buy a computer for a software engineer to use, then the engineer will not have a computer on which to develop a software program for the first project.

When one project depends on another project, the one project is the “dependent project,” while the other project is the “depended-upon project.” Any particular project can be a “dependent project” with respect to one or more other projects and a “depended-upon project” with respect to yet other projects.

### System

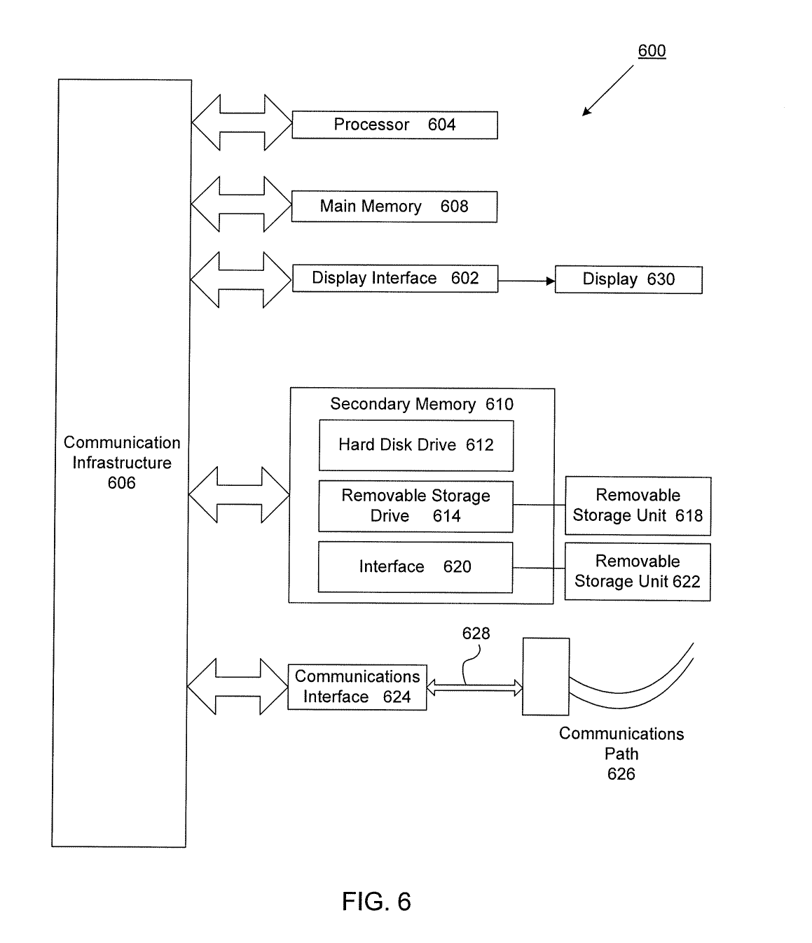

Preferably, the methods of managing project risk according to the present invention are implemented through software operating on a computer system. An example of a computer system 600 employed in the methods of the invention is shown in FIG. 6.

The computer system 600 includes one or more processors, such as processor 604. The processor 604 is connected to a communication infrastructure 606 (e.g., a communications bus, cross-over bar, or network). After reading this description, it will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on the display unit 230.

Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, and so on. The removable storage drive 614 reads from and/or writes to a removable storage unit 618 in a well-known manner. Removable storage unit 618 represents a floppy disk, magnetic tape, optical disk, and so on, which is read by and written to by removable storage drive 614. As will be appreciated, the removable storage unit 618 includes a computer usable storage medium having stored therein computer software and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface N24 may include a modem, a network interface (such as an Ethernet card), a communications port, a Personal Computer Memory Card International Association (PCMCIA) slot and card, and so on. Software and data transferred via communications interface 624 are in the form of signals 628 which may be electronic, electromagnetic, optical, or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, a radio frequency (RF) link, and other communications channels.

In this document, the terms “computer program medium” and “computer usable medium” are used to generally refer to media such as removable storage drive 614, a hard disk installed in hard disk drive 612, and signals 628. These computer program products provide software to computer system 600.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 604 to perform the features of the present invention. Accordingly, such computer programs represent controllers of the computer system 600.

In an embodiment where the invention is implemented using software, the software may be stored in a computer program product and loaded into computer system 600 using removable storage drive 614, hard drive 612, or communications interface 624. The control logic (software), when executed by the processor 604, causes the processor 604 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### Dynamic Risk Management

Dynamic risk management according to the present invention can be implemented in business environments to effectively manage multiple projects that may be interdependent and/or that may have many associated risks. Most conventional systems take risks into consideration, but they do not update the risks, nor properly incorporate mitigation solutions prior to the occurrence of any such risks. As a result, when adverse events occur, there can be undesirable consequences such as loss of money, time delays, and wasting of human resources.

One of the novel features of the present invention is that mitigation is factored into each project in advance of the occurrence of a risk associated with the project. A target time is set for a mitigation plan to be inputted (indicating either existence of a plan or the completion of a plan), for example, into a database, and if that plan is not inputted by the target time, then the priority of the risk (and therefore the project) is increased. Increasing the priority level of a project attracts a manager's attention to potential problems. The manager can then take appropriate actions (including formulating or implementing a mitigation plan) in order to avoid the problems completely or mitigate the adverse effects of the problems.

Another of the novel features of the present invention is the linking of the risks and mitigation associated with interdependent projects (described later in further detail). This allows a manager to appreciate the overall risk of a particular project, not in isolation, but in the context of some or all of the projects (including related projects) being managed.

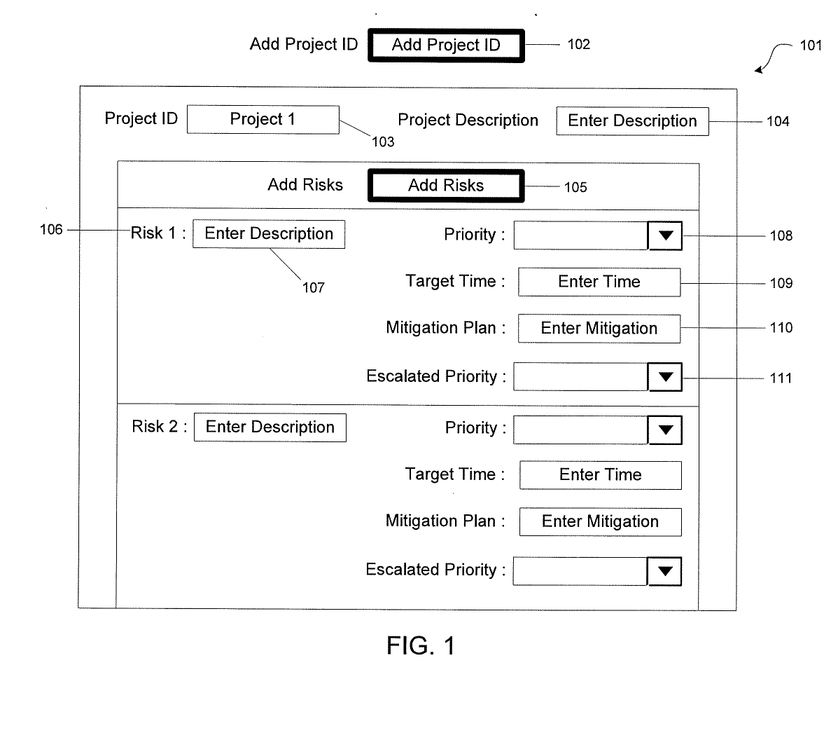

Exemplary embodiments of the invention will now be described with reference to FIGS. 1, 2, 3, 4, and 5.

FIG. 1 shows a graphical user interface (GUI) on a display screen 101, such as a computer monitor. As seen in FIG. 1, the GUI includes a button 102 for adding a project ID, such as “Project 1,” “Project 2,” and so on. A field 103 is for receiving and displaying an entered project ID, and a field 104 is for receiving and displaying a project description, such as “develop software program A.” By clicking on the button 102 one or more times, the description and risks for multiple projects can be inputted and stored, for example, in a computer database.

A button 105 is for adding one or more risks associated with a project ID. Each added risk is identified by a risk ID 106. In this example, “Risk 1” is automatically set as the risk ID for a first added risk, but the GUI can be designed to receive and display any risk ID entered by a user. A field 107 is for receiving and displaying a risk description, such as “insufficient funding.” Field 108 is for receiving and displaying a priority assigned to a risk, such as the risk of insufficient funding. If desired, the GUI can be designed so that when the field 108 is clicked on, a drop-down box appears, displaying a list of pre-set choices for priority, such as priority values 1, 2, 3, 4, and so on until 50. Alternatively, the field 108 can receive and display any priority that a user types in (or otherwise enters into the field). A priority scaling system can be arranged such that a higher numerical priority value indicates greater priority, or such that a lower numerical priority value indicates greater priority. Priority values can also be based on letters (for example, priority value A can indicate a low priority, while priority value L can indicate a higher comparative priority), on a combination of letters and numbers (A1, A2, . . . , L1, L2, and so on), on descriptive words (low priority, medium priority, high priority, urgent priority, and so on), or on any other desired scaling system.

A field 109 is for receiving and displaying a target time by which a mitigation plan should be present for a particular risk, such as Risk 1 in this example. The target time can be the time elapsing after an initial time, for example, seven days (or some other amount of time) after the time that the risk description in this example is identified and entered into the computer database. Alternatively, the target time can be any particular time not necessarily related to an initial time, for example, 3:00 PM on Sep. 27, 2007.

Field 110 is for receiving and displaying a mitigation plan for responding to a particular risk associated with a project, should the risk occur. For instance, a mitigation plan for the risk of insufficient funding may be “requesting quarterly budgeting of funds from the business committee.” If no mitigation plan is present, for example, anywhere in the computer system 600, and the current time is past the target time, then the priority associated with the particular risk is escalated to a priority higher than the initial priority received and displayed in the field 108. A field 111 is for receiving and displaying the escalated priority. Again, the GUI shown in FIG. 1 can be designed so that when the field 111 is clicked on, a drop-down box appears, displaying a list of pre-set choices for priority, or the field 108 can be designed to receive and display any priority that a user types in.

The initial priority and escalated priority can each be determined and entered by a user of the GUI interface. Alternatively, the priority values can be automatically determined and entered based on default and/or customized associations between particular risks and priority values. As well, a risk management method or system can be designed so that if certain pre-set project descriptions are entered, default and/or customized risks are automatically associated with the entered projects. Entry of target times can also be automatic, based on default and/or customized associations between particular risks and optimal time periods by which mitigation plans should be formulated. Thus, according to the present invention, the entry of information in a method of managing project risk can involve automation and user input in varying degrees.

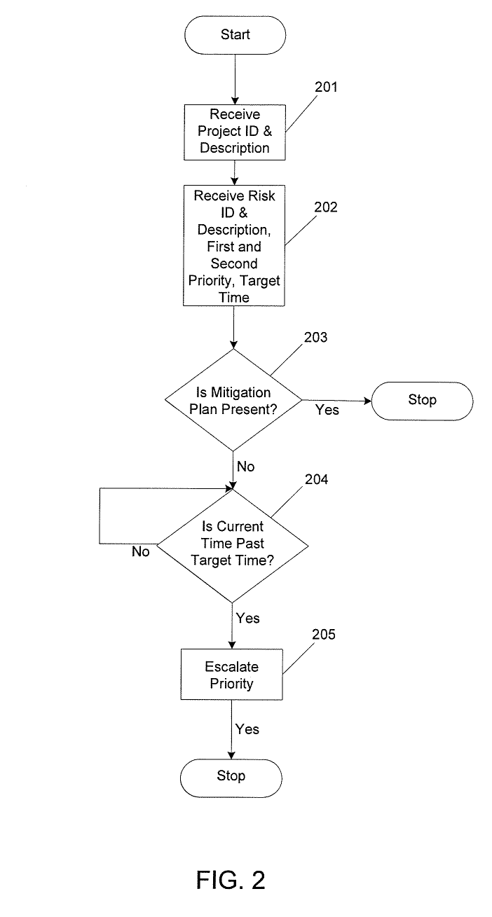

FIG. 2 is a flowchart illustrating how the GUI shown in FIG. 1 can be used in a method of managing project risk according to the present invention. At 201, a project ID and a project description are received and stored, for example, in a computer database. At 202, a risk ID, risk description, first priority associated with the risk, a second priority associated with the risk, and a target time for entry of a mitigation plan for the risk are each received and stored. The priority value associated with the risk (and with the risk description) is initially set to equal the first priority. At 203, if a mitigation plan for the risk is present, for example, in a main or secondary memory of the computer system 600 (or if the plan has been executed), then the process stops. However, if no mitigation plan is present, the process continues to 204. If the current time is past the target time, then the process continues to 205, wherein the priority value associated with the risk (and with the risk description) is set to equal the second, escalated priority. As an example, if no mitigation plan is present for the risk of insufficient funding and the current time is past the target time, then the priority associated with the risk is increased from an initial priority of 25 to an escalated priority of 60.

As an alternative, after the priority value associated with the risk (and with the risk description) is initially set to equal the first priority, the priority value is maintained at the first priority prior to the target time. Checking for entry (or execution) of a mitigation plan associated with the risk description occurs, and the priority value of the risk description is set to be equal to the second priority if a mitigation plan associated with the risk description is not entered by the target time.

At any time, a user can request outputting of the priority value of a particular risk or risk description. Such outputting can take the form of a screen display, a printout, an e-mail report, or any other conventional forms of outputting. Also, outputting of a priority value for one or more risks can be designed to occur automatically when the priority value reaches or exceeds a pre-set value, when the number of risks not having a mitigation plan meets or exceeds a pre-set value, when another pre-set criterion is satisfied, and so on.

The GUI of FIG. 1 can also be designed to prompt for the entry of a mitigation plan associated with a risk (and with a risk description), if no such mitigation plan is present. The prompting can be set to occur during initial entry of a particular risk and risk description, at any one specific time after such initial entry (for example, by close of business on the following Friday), or at pre-set intervals (equal or unequal in length) after such initial entry. Preferably, the prompting is set to occur when the target time has been reached and no mitigation plan is present. Similarly, these prompts may be used for an entry indicating that the mitigation plan has been executed. Thus, there may be prompting for entry of a plan and/or the execution of the plan.

Thus, according to the present invention, a user such as a business manager can view project reports reflecting multiple risks, each of which is associated with an initial priority value or an escalated priority value. The escalated priorities can draw the manager's attention to risks that do not yet have any mitigation plans, thereby encouraging the manager to formulate and/or enter such mitigation plans so as to minimize or eliminate adverse effects if any enumerated risks do occur. As well, the manager can be actively prompted to formulate and/or enter such mitigation plans.

### Project Dependency

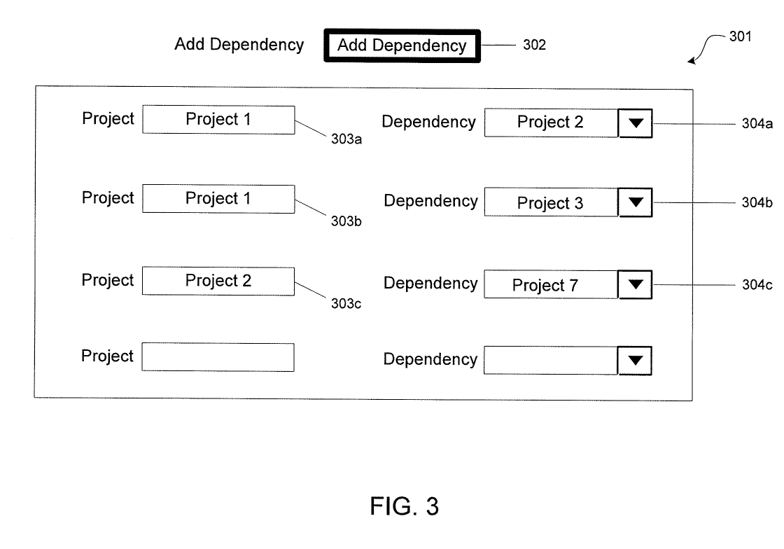

The present invention also recognizes that individual projects being managed in a business environment, rather than existing in a vacuum, often depend on one or more other projects also being managed. FIG. 3 shows a graphical user interface that can be used to link or associate related projects together in a method of managing risk according to the present invention.

The GUI of FIG. 3 appears on a display screen 301, such as a computer monitor. A button 302 is provided for adding a dependency to a particular project. When the button 302 is clicked, project fields 303a, 303b, 303c (and so on) and dependency fields 304a, 304b, 304c (and so on) appear on the screen display 301. The project fields are for receiving and displaying the project IDs of projects that are each to be assigned a dependency on one or more other projects. The dependency fields are for receiving and displaying the project IDs of projects that are each depended upon by one or more other projects. The present example indicates that Project 1 depends on Project 2 (303a, 304a), that Project 1 also depends on Project 3 (303b, 304b), and that Project 2 depends on Project 7 (303c, 304c). In this example, Project 1 and Project 2 are each dependent projects, while Project 2, Project 3, and Project 7 are each depended-upon projects. Project 2 is both a dependent project and a depended-upon project. FIG. 3 thus illustrates how multiple projects can be interdependent.

The GUI of FIG. 3 can be designed so that when the project fields 303a, 303b, 303c are clicked, or when the dependency fields 304a, 304b, 304c are clicked, pre-populated drop-down boxes appear, allowing a user to select from lists of project IDs. If desired, the GUI can be designed so that the drop-down boxes for the dependency fields 304a, 304b, 304c are automatically populated based on what has been entered in the project fields 303a, 303b, 303c. Of course, the GUI can be designed to receive and display any input by the user in the project fields and the dependency fields.

### Risk Inheritance

Once related projects are linked together as described above, the present invention can provide, for any particular project, an overall or resultant risk arising from the risks associated with the project in itself and the risks inherited from depended-upon projects.

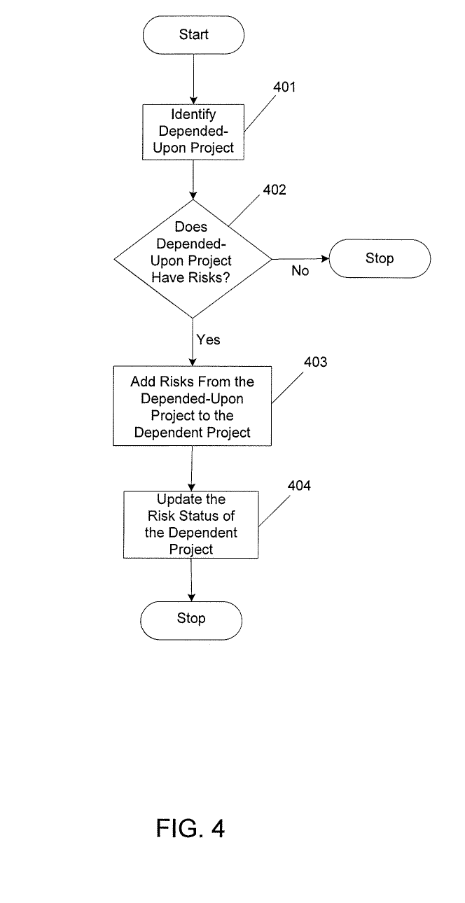

When a first project depends on a second project, the first project “inherits” the risks of the second project. FIG. 4 is a flowchart illustrating risk inheritance of one project from another project in a method of managing risk according to the present invention.

For the example shown in FIG. 3, Project 1 is a project under consideration for overall risk. Initially, before any dependency is assigned, it has a risk status determined based only on its “own” risks, that is, any risks with which it is immediately associated. At 401, a depended-upon project is identified. For the example shown in FIG. 3, Project 2 is identified as a depended-upon project of Project 1. At 402, the depended-upon Project 2 is checked for associated risks. If there are no risks, the process stops. However, if Project 2 has associated risks, then the process moves to 403, wherein the risks of the depended-upon Project 2 are added to the dependent Project 1. That is, Project 1 inherits the risks immediately associated with Project 2. At 404, the risk status of Project 1 is updated to take into account the inherited risks, such that the risk status of Project 1 reflects all of the risks of Project 1 in itself and the risks of Project 2 in itself. For the example shown in FIG. 3, the process of FIG. 4 is repeated since Project 1 also depends on Project 3, with the result that the risk status of Project 1 is further updated because of risk inheritance from Project 3.

Further, the present invention addresses situations wherein a depended-upon project is itself subject to risk inheritance. For the example shown in FIG. 3, Project 1 depends on Project 2 and inherits the risks of Project 2, as already described. However, Project 2 itself depends on Project 7, meaning that Project 2 inherits the risks immediately associated with Project 7. The methods of the invention can be designed so that Project 1 accordingly inherits the risks of Project 7 through the intermediary Project 2. Thus, the overall risk status of Project 1 would reflect risks associated with Project 1, Project 2, and Project 7. If Project 7 also inherits risks from yet another project, methods can be designed so that Project 1 inherits those risks as well.

The point after which risks are no longer inherited can be set by default or customized by a user. For example, a user may prefer that only first- and second-order dependencies are taken into consideration for purposes of risk inheritance. An example of a first-order dependency is the direct dependency of Project 1 on Project 2, and an example of a second-order dependency is the indirect dependency of Project 1 on Project 7. If Project 7 depends, for instance, on Project 8, then an example of a third-order dependency would be the indirect dependency of Project 1 on Project 8. The user may determine that it is not helpful (or only marginally helpful) or undesirable for some other reason to update the overall risk status of Project 1 to include risks inherited due to third- or even higher-order dependencies.

Checking for nth-order dependencies and updating of overall risk status can be designed to occur upon user request. The checking and updating can also be designed to occur at pre-set times, and/or upon entry of a dependency relationship. For example, at the time that Project 2 is designated as being dependent on Project 7, the computer system 600 can check pre-existing projects to see if any depend on Project 2. The system will determine that Project 1 depends on Project 2, and accordingly update the risk status of Project 1 to take into account the risks of Project 7.

### Reporting of Risk Status

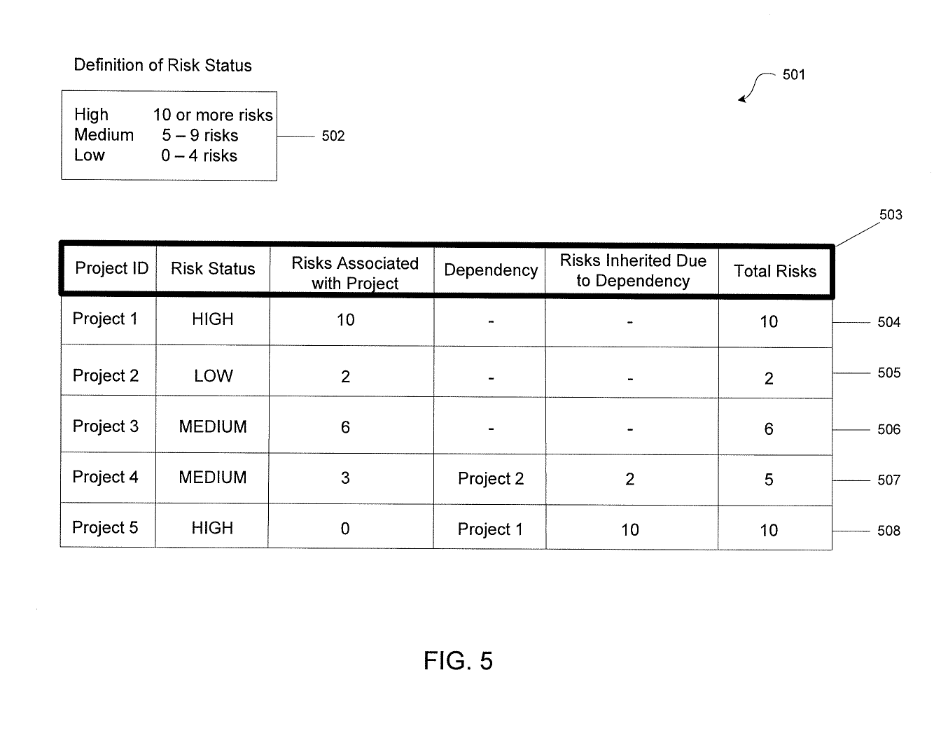

FIG. 5 shows a sample report of the risk status of several projects being managed in a method of managing risk according to the present invention.

Displayed on display screen 501 is a box 502 indicating definitions for different risk statuses. A “High” risk status means that a project is associated with 10 or more risks (which can be the project's “own” risks or risks inherited due to any order of dependency). “Medium” risk status means that a project is associated with 5-9 risks, and “Low” risk status means that a project is associated with 0-4 risks. Other and more risk statuses besides High, Medium, and Low may be used, and the number of risks associated with each status can be varied according to preference and/or preferred business practice.

Table 503 shows five projects, together with risk status, project-associated risks, dependency, inherited risks, and total risks for each project. Table rows 504, 505, and 506 show that Projects 1, 2, and 3 have risk statuses based respectively on each project's “own” risks. Projects 1, 2, and 3 are not dependent on any other projects, and their respective total risks are the same as the number of project-associated risks. However, as seen in row 507, Project 4 depends on Project 2. Thus, while Project 4 by itself is a project with Low risk status (3 risks), the risks inherited from Project 2 (2 risks) bring the total risk to 5, making Project 4 a project with Medium overall risk status. As seen in row 508, Project 5 depends on Project 1. Thus, while Project 5 by itself is a project with Low risk status (0 risks), the risks inherited from Project 1 (10 risks) bring the total risk to 10, making Project 5 a project with High overall risk status, despite the fact that it does not have any of its “own” risks.

With the present invention, a user such as manager can be alerted, for example, to the High risk status of a new project that may not otherwise appear to have any risks at all. A manager receiving the report of FIG. 5 may then be encouraged, for example, to formulate mitigation plans for Project 1 in order to bring down the risk status of both Project 1 and Project 5. Or, the manager might make changes in the organization or planning of Project 5 so that it is no longer dependent on another project with as high a risk status as Project 1. Further, the report of FIG. 5 can be combined with project reports discussed above.

The “risk status” of a project can reflect simply the number of risks associated with the project, and/or it can reflect the number of associated risks that do not have mitigation plans. Risks can also be “weighted” such that, for example, a risk with a mitigation plan counts as one risk, but a risk without a mitigation plan counts as 1.5 risks, for the purpose of determining risk status. Further, risks can be weighted based on the initial and/or the escalated priority value of the risk. For example, a risk with a current priority value of 25 may count as one risk, but a risk with a current priority value of 75 may count as two risks, for the purpose of determining risk status. It is preferable for risk status to be determined based on risk weighting that takes into account dynamically updated priority values and/or presence and absence of mitigation plans. In this way, a report of risk status for multiple interdependent projects, such as the report shown in FIG. 5, can provide a current, accurate, and complete assessment of the degree of risk associated with all of the projects being managed.

At any time, a user can request outputting of a report regarding the risk status of one or more projects. Also, the outputting of a report regarding risk status can be designed to occur automatically based on time (such as once a week or once a month) and/or whenever there is a change in the risk status of one or more projects.

The methods of the present invention are adaptable for use in a computer-implemented enterprise system. However, the methods described herein are not limited to such an environment, and can be applied in any environment in which multiple interdependent projects are being managed. For example, dynamic risk management would be appropriate for the numerous projects that together result in the design and building of a bridge, or the construction of railroad tracks.

While embodiments of the present invention have been described above, it should be understood that they have been presented by way of example, and not by way of limitation. It will be apparent to persons skilled in the relevant art(s) that various changes in form and detail can be made therein without departing from the spirit and scope of the present invention. The present invention should be defined only in accordance with the following claims and their equivalents.

Further, the purpose of the Abstract is to enable the U.S. Patent and Trademark Office and the general public, who may not be familiar with patent or legal terms, to quickly determine the nature and essence of the technical disclosure of the application. The Abstract is not intended to limit the scope of the present invention in any way.

What is claimed is:

1. A method of managing project risk in a business environment, comprising:
receiving a risk description, a first priority associated with the risk description, a second priority associated with the risk description, and a target time associated with the risk description;
setting a priority value of the risk description to be equal to the first priority;
comparing a current time with the target time;
checking for presence of a mitigation plan associated with the risk description;
setting the priority value of the risk description to be equal to the second priority, if no mitigation plan associated with the risk description is present and the current time is after the target time; and
outputting the priority value of the risk description.

2. The method of claim 1, further comprising:
prompting for entry of a mitigation plan associated with the risk description, if no mitigation plan associated with the risk description is present.

3. The method of claim 2, wherein the prompting occurs at the target time.

4. The method of claim 1, wherein the priority value is set based on a third priority associated with an interrelated project.

5. The method of claim 4, wherein the priority value of the project and a priority value of the interrelated project are each set to be equal to the highest priority value associated with either the project or the interrelated project.

6. A method of managing project risk in a business environment, comprising:
receiving first risk information comprising information regarding one or more risks associated with a first project;
setting a first project risk status based on the first risk information;
receiving second risk information comprising information regarding one or more risks associated with a second project;
setting a second project risk status based on the second risk information;
checking for a positive dependency status of the first project indicating that the first project depends on the second project;
updating the first project risk status based on the first risk information and the second risk information, if the dependency status of the first project is positive; and
outputting the first project risk status.

7. The method of claim 6, further comprising:
checking for a positive dependency status of the second project indicating that the second project depends on the first project; and
updating the second project risk status based on the second risk information and the first risk information, if the dependency status of the second project is positive.

8. The method of claim 6, wherein the first project risk status is outputted when there is a change in the first project risk status.

9. The method of claim 6, wherein the first risk information includes at least one of (a) priority value information and (b) mitigation information.

10. A computer program product comprising a computer usable medium having control logic stored therein for causing a computer to manage project risk in a business environment, the control logic comprising:
first computer readable program code means for causing the computer to receive a risk description, a first priority associated with the risk description, a second priority associated with the risk description, and a target time associated with the risk description;
second computer readable program code means for causing the computer to set a priority value of the risk description to be equal to the first priority;
third computer readable program code means for causing the computer to compare a current time with the target time;
fourth computer readable program code means for causing the computer to check for presence of a mitigation plan associated with the risk description;
fifth computer readable program code means for causing the computer to set the priority value of the risk description to be equal to the second priority, if no mitigation plan associated with the risk description is present and the current time is after the target time; and
sixth computer readable program code means for causing the computer to output the priority value of the risk description.

11. The computer program product of claim 10, wherein the control logic further comprises:
seventh computer readable program code means for causing the computer to prompt for entry of a mitigation plan associated with the risk description, if no mitigation plan associated with the risk description is present.

12. The computer program product of claim 11, wherein the seventh computer readable program code means causes the computer to prompt, at the target time, for the entry of the mitigation plan.

13. The computer program product of claim 10, wherein the priority value is set based on a third priority associated with an interrelated project.

14. The computer program product of claim 13, wherein the priority value of the project and a priority value of the interrelated project are each set to be equal to the highest priority value associated with either the project or the interrelated project.

15. A computer program product comprising a computer usable medium having control logic stored therein for causing a computer to manage project risk in a business environment, the control logic comprising:
first computer readable program code means for causing the computer to receive first risk information comprising information regarding one or more risks associated with a first project;
second computer readable program code means for causing the computer to set a first project risk status based on the first risk information;
third computer readable program code means for causing the computer to receive second risk information comprising information regarding one or more risks associated with a second project;
fourth computer readable program code means for causing the computer to set a second project risk status based on the second risk information;
fifth computer readable program code means for causing the computer to check for a positive dependency status of the first project indicating that the first project depends on the second project;
sixth computer readable program code means for causing the computer to update the first project risk status based on the first risk information and the second risk information, if the dependency status of the first project is positive; and
seventh computer readable program code means for causing the computer to output the first project risk status.

16. The computer program product of claim 15, wherein the control logic further comprises:
eighth computer readable program code means for causing the computer to check for a positive dependency status of the second project indicating that the second project depends on the first project; and
ninth computer readable program code means for causing the computer to update the second project risk status based on the second risk information and the first risk information, if the dependency status of the second project is positive.

17. The computer program product of claim 15, wherein the seventh computer readable program code causes the first project risk status to be outputted when there is a change in the first project risk status.

18. The computer program product of claim 15, wherein the first risk information includes at least one of (a) priority value information and (b) mitigation information.

19. A computer system for managing project risk in a business environment, comprising:
a processor;
an output; and
a memory,
wherein the processor performs processes comprising:
causing the computer system to store, in the memory, a risk description, a first priority associated with the risk description, a second priority associated with the risk description, and a target time associated with the risk description;
setting a priority value of the risk description to be equal to the first priority;
comparing a current time with the target time;
checking the memory for presence of a mitigation plan associated with the risk description;
setting the priority value of the risk description to be equal to the second priority, if no mitigation plan associated with the risk description is present in the memory and the current time is after the target time; and
outputting the priority value of the risk description through the output.

20. The computer system of claim 19, wherein the processes further comprise prompting for entry of a mitigation plan associated with the risk description, if no mitigation plan associated with the risk description is present in the memory.

21. The computer system of claim 20, wherein the prompting occurs at the target time.

22. The computer system of claim 19, wherein the priority value is set based on a third priority associated with an interrelated project.

23. The computer system of claim 22, wherein the priority value of the project and a priority value of the interrelated project are each set to be equal to the highest priority value associated with either the project or the interrelated project.

24. A computer system for managing project risk in a business environment, comprising:
a processor;
an output; and
a memory,
wherein the processor performs processes comprising:
causing the computer system to store, in the memory, first risk information comprising information regarding one or more risks associated with a first project;
setting a first project risk status based on the first risk information;
causing to computer system to store, in the memory, second risk information comprising information regarding one or more risks associated with a second project;
setting a second project risk status based on the second risk information;
checking for a positive dependency status of the first project indicating that the first project depends on the second project;
updating the first project risk status based on the first risk information and the second risk information, if the dependency status of the first project is positive; and
outputting the first project risk status through the output.

25. The computer system of claim 24, wherein the processes further comprise:
checking for a positive dependency status of the second project indicating that the second project depends on the first project; and
updating the second project risk status based on the second risk information and the first risk information, if the dependency status of the second project is positive.

26. The computer system of claim 24, wherein the processor causes the first project risk status to be outputted when there is a change in the first project risk status.

27. The computer system of claim 24, wherein the first risk information includes at least one of (a) priority value information and (b) mitigation information.
